(19) United States
(12) Patent Application Publication
(10) Pub. No.: US 2015/0363521 A1
(43) Pub. Date: Dec. 17, 2015

(54) Conducting a Sensor Network Survey

(71) Applicant: HEWLETT-PACKARD DEVELOPMENT COMPANY, L.P., Houston, TX (US)

(72) Inventors: RAVIGOPAL VENNELAKANTI, PALO ALTO, CA (US); AMIT KUMAR, PALO ALTO, CA (US); XIN (ALEX) ZHANG, PALO ALTO, CA (US)

(73) Assignee: Hewlett-Packard Development Company, L.P., Houston, TX (US)

(21) Appl. No.: 14/763,242

(22) PCT Filed: Jan. 24, 2013
(86) PCT No.: PCT/US2013/023001

§ 371 Date: Jul. 24, 2015

(51) Int. Cl. G06F 17/50; H04W 4/00

(52) U.S. Cl. CPC G06F 17/509; H04W 4/006; G06F 17/5009; H04W 84/18

(57) ABSTRACT

A method of conducting a sensor network survey comprising, with a processor: determining a number of daily operations to perform in a survey, determining a number of fixed parameters of the daily operations; determining a number of control parameters of the daily operations, determining flow times of the daily operations using a queue equation, determining a total flow time of the daily operations, executing a simulation module to determine at least one scenario, and outputting the at least one scenario to an output device.

### BACKGROUND

In certain systems, data may be received by a processing device from a number of sensor devices deployed across a wide area. The sensors are used to detect parameters of interest in order to provide information to a user about the environment in which the sensor devices are deployed. The output of a sensor device may be sampled on a periodic basis and written to a cache of the processing device, where the processing device can then access and manage data according to a particular application.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a seismic sensing system, according to one example of the principles described herein.

FIG. 2 is a diagram of a survey operation, according to one example of the principles described herein.

FIG. 3 is a diagram of daily operations of the survey operation of FIG. 2, according to one example of the principles described herein.

FIG. 4 is a diagram of a survey operation device of the seismic sensing system of FIG. 1, according to one example of the principles described herein.

FIG. 5 is a flowchart showing a method (500) of conducting a sensor network survey, according to one example of the principles described herein.

Throughout the drawings, identical reference numbers designate similar, but not necessarily identical, elements.

### DETAILED DESCRIPTION

These types of surveys performed with the deployed sensor devices are expensive and difficult to manage for various reasons. One reason a distributed sensor system may be expensive and difficult to manage is the location in which the sensor system is deployed. In the example used in the present disclosure, the sensors are used to detect, seismic activity across 1600 square kilometers or more in order to detect potential oil and gas resources in the target area. The target area may be an extremely rural area such as a desert or a tundra, so access to the target area adds to expenses incurred in deployment of the sensor system and processing of the survey. This expense is compounded when personnel, equipment, and other resources are being continually utilized during the survey.

A contract may be entered into between a client and a contractor in which the contractor is employed to conduct the survey. Therefore, the contractor may be liable for any additional expenses incurred during the survey above what may be economically outlined in the contract. Therefore, careful planning of how the survey is to be conducted and how resources are utilized may assist in reducing or eliminating any additional costs. More specifically, daily planning of processes and sub-processes may assist the contractor in processing the survey while not incurring additional costs.

Further, in performing the survey and its various processes and sub-processes, execution of one process or sub-process too early or too late may drastically affect a number of other processes and sub-processes. In other words, the various processes and sub-processes are interdependent. For example, deployment of a number of sensors in the field too early may result in the sensors' batteries depleting earlier than expected, and data acquisition processes performed by the sensors may be negatively affected. On the other hand, deployment of the sensors in the field too late may delay other processes or sub-processes that follow the sensor deployment process. Therefore, careful planning of the overall survey process and the day-to-day processes reduce or eliminate possible bottlenecks among the interdependent processes and sub-processes.

The present disclosure therefore describes a method of conducting a sensor network survey. The method comprises, with a processor, executing an operations module to determine a number of daily operations to perform in a survey, executing a fixed parameters module to determine a number of fixed parameters of the daily operations, and executing a control parameters module to determine a number of control parameters of the daily operations. The method further comprises executing a queue module to determine flow times of the daily operations using a queue equation, executing a queue module to determine a total flow time of the daily operations, executing a simulation module to determine a number of scenarios, and outputting the scenarios to an output device. As generally described herein, a flow time indicates a time required for completing an operation.

Further, the present disclosure describes a survey operation device comprising a processor, and a data storage device coupled to the processor. The data storage device comprises an operations module to determine a number of operations to perform in a survey, a fixed parameters module to determine a number of fixed parameters of the operations, and a control parameters module to determine a number of control parameters of the operations. The data storage device further comprises a queue module to determine flow times of the operations using a queue equation and to determine a total flow time of the operations, a simulation module to determine a number of scenarios, and an output device to output the scenarios.

Still further, the present disclosure describes a computer program product for conducting a sensor network survey, the computer program product comprising a computer readable storage medium comprising computer usable program code embodied therewith. The computer usable program code comprises computer usable program code to, when executed by a processor, determine a number of operations to perform in a survey, computer usable program code to when executed by the processor, determine a number of fixed parameters of the operations, and computer usable program code to, when executed by the processor, determine a number of control parameters of the operations. The computer usable program code further comprises computer usable program code to, when executed by the processor, determine flow times of the operations using a queue equation, computer usable program code to, when executed by the processor, determine a total flow time of the operations, and computer usable program code to, when executed by a processor, determine a number of scenarios.

Thus, the present systems and methods formulate a realistic plan for number of days during the survey based on a known amount of resources and known operating times. The present systems and methods also assess the impact of a particular day's operations by determining if actual values of the parameters of the survey are different than what was planned, and plans for a next day's processes and sub-processes based on the difference between the expected values and the actual values. Still further, the present systems and methods assess the impact of a delay in a process or sub-process on the overall survey.

As used in the present specification and in the appended claims, the terms “mega-channel,” “mega-channel sensor system,” “multiplexed data stream,” or similar language is meant to be understood broadly as any comp, ng process or system whereby multiple sets of data from different sources (i.e. channels) are linked and/or housed together and then analyzed to provide information about the multiple sets of data. This provides effective and successful decision-making information to an administrator. In one example, the different sources from which the multiple sets of data are obtained may comprise a number of sensors distributed in a wide area, a processing center or base camp where processing of data occurs, a command center where the survey process is controlled, a number of vibroseis trucks used to stimulate the environment in which the sensors are deployed, and a number of personnel working on the survey and their computing devices. Further, the different sources from which the multiple sets of data are obtained may comprise a number of applications that are running within the survey system such as, for example, a crew management application, a resource management application, health safety applications, agency applications, and combinations thereof. Still further, the sources may comprise information provided by any other source that provides update information regarding the above sources. In another example, the different sources from which the multiple sets of data are obtained may comprise any combination of the foregoing.

As used in the present specification and in the appended claims, the terms “sensor,” “node,” or similar terms are meant to be understood broadly as any device used to detect a number of environmental or physical quantities, and convert it into a signal which can be interpreted by a computing device. In one example, the sensors are high resolution Richter sensor nodes (RSNs) developed and sold by Hewlett-Packard Company. The Richter sensors are cost-effective, accurate, and high-end inertial measurement units (IMUs) capable of measuring movement on the x-, y-, and z-axis, as well as pitch, roll and yaw, all on a single, homogenous planar chip. Richter sensors provide these six axes of sensing while overcoming the inherent orthogonal inaccuracy produced by other IMUs. In addition to the devices used to detect movement, an RSN comprises a number of additional computing devices that compute and store data associated with the detected movement. Further, the RSNs communicate wirelessly through, for example, wireless fidelity (Wi-Fi) communications modules. Thus, the RSNs comprise elements built around a sensor device that capture, process, store, and transmit the data collected from the sensor device.

In the example of the sensors, the number of sensors may range from one sensor to approximately one million sensors. In one example, each individual sensor may provide more than one type or channel of information.

Even still further, as used in the present specification and in the appended claims, the term “a number of” or similar language is meant to be understood broadly as any positive number comprising 1 to infinity; with zero indicating the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

The present systems and methods utilize wireless, digital sensor devices that may be deployed at a relatively larger scale: approximately one million sensor devices or more at a time. In one survey design, the system may have approximately one million sensors spread over a 40×18.4 km² area, connected wirelessly to a command center. Based on specific survey plan options selected, each day 24,000 to 100,000 sensors may be retrieved from one side of the survey grid or target area, and redeployed to the other side of the survey area, so as to cover a total acreage of 40×40 km² during the surveying project.

Thus, the present systems and methods provide a land-based seismic imaging system for, among other applications, oil and gas exploration through the use of a mega channel system for the acquisition of seismic data and field management of that data. The system further provides a centralized monitoring and controlling system in an in-field, mobile command center that provides field storage and processing of data to ensure that the deployed sensor array is functioning properly and capturing seismic data accurately and precisely.

In the following description, the example of a number of seismic sensor devices distributed on land within a wide area is presented in order to provide a thorough understanding of the present systems and methods. However, any distributed sensor system deployed in any environment may be used in connection with the stream data processing systems and methods described herein. The sensor devices that make up the distributed sensor system may be any type of sensor that may gather any type of data associated with the environment in which the sensor devices are deployed. The sensors of the present specification may be any data producing device or other apparatus or system that provides a measurement or digital data to a receiving device. The data producing device may transmit the data directly to the receiving device, provide the data at a node that is sampled by the receiving device, or a combination thereof. The data may include an analog measurement, a digital sequence of bits, or a combination thereof. These distributed sensor systems may be utilized in any context.

For example, the sensors and the systems of the present application may be deployed in the health care industry. In this example, the sensors may be deployed to sense and monitor a number of vital signs of a number of health care patients. Another example in which the present systems and methods may be deployed includes monitoring of infrastructure such as roads, bridges, water supplies, sewers, electrical grids, and telecommunications among others. Still another example may be the monitoring of various components of a vehicle such as an airplane. Still another example in which the present systems and methods may be deployed comprises the monitoring of brainwaves. Thus, although the presented systems and methods have application in almost any area of data acquisition and analysis, the present disclosure will describe these systems and methods in the context of a number of seismic sensor devices distributed on land within a wide area. Further, the present systems and methods may be employed in any context or scenario where field operations and operation logistics utilize manual and automated systems.

Throughout the present disclosure, various computing elements and devices are used in connection with the collection, analysis, and visualization of large amounts of data obtained from a distributed sensor array. To achieve its desired functionality, the system (100) comprises various hardware components. Among these hardware components may be a number of sensors, a number of processing devices, a number of data storage devices, a number of peripheral device adapters, and a number of network adapters, among other types of computing devices. In one example, these hardware components may be interconnected through the use of a number of busses and/or network connections. In another example, the hardware components May make up a single overall computing device or system. In still another example, the hardware components may be distributed among a number of computing devices that are interconnected through the use of a number of busses and/or network connections.

The present systems described herein may comprise a number of computer processing devices. The computer processing devices may include the hardware architecture to retrieve executable code from a data storage device and execute the executable code. The executable code may, when executed by the computer processing devices, cause the computer processing devices to implement at least the functionality of planning and monitoring of daily survey operations and an overall survey operation, according to the methods of the present specification described herein. In the course of executing code, the computer processing devices may receive input from and provide output to a number of the remaining hardware units.

The data storage devices described herein may store data such as executable program code that is executed by the computer processing devices. As will be discussed, the data storage devices may specifically store a number of applications that the computer processing devices execute to implement at least the functionality described herein.

The data storage devices may include various types of memory modules, including volatile and nonvolatile memory. For example: the data storage devices may include Random Access Memory (RAM), Read Only Memory (ROM), and Hard Disk Drive (HDD) memory. Many other types of memory may also be utilized, and the present specification contemplates the use of many varying types) of memory in the data storage devices as may suit a particular application of the principles described herein, in certain examples, different types of memory in the data storage devices may be used for different data storage needs. For example, in certain examples the computer processing devices may boot from Read Only Memory (ROM), maintain nonvolatile storage in the Hard Disk Drive (HDD) memory, and execute program code stored in Random Access Memory (RAM).

The data storage devices described herein may comprise a computer readable storage medium. For example, the data storage devices may be: but are not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

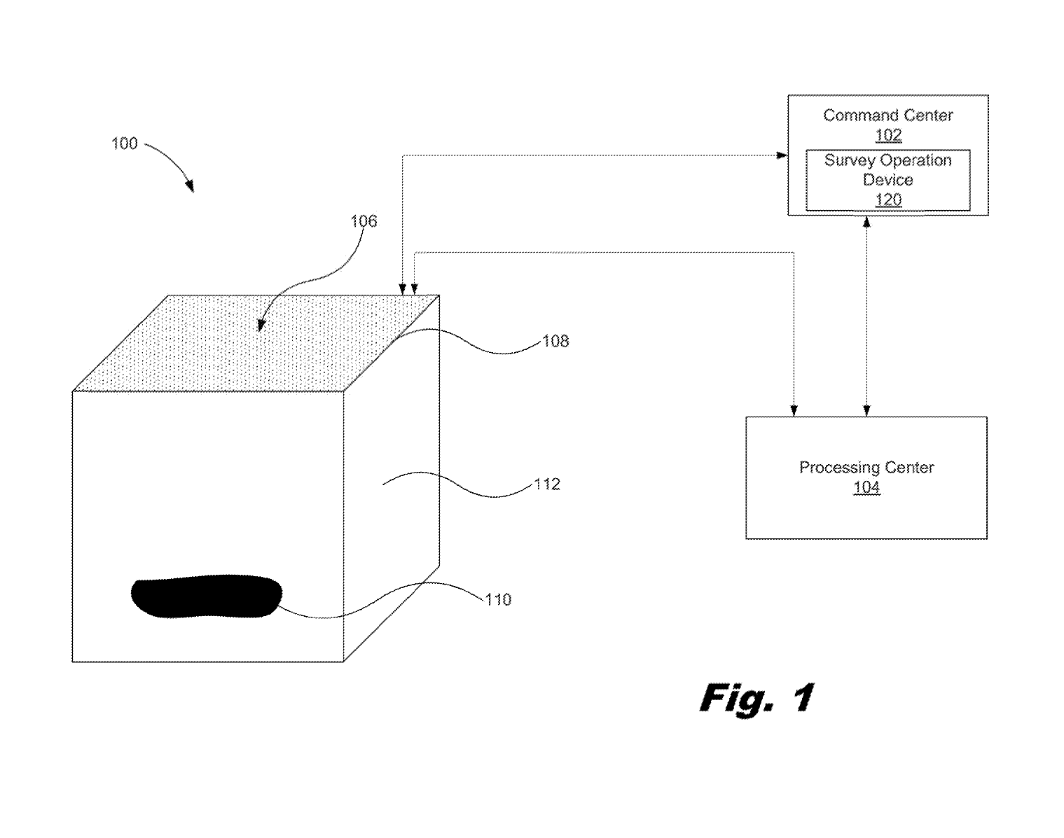

Turning now to the figures, FIG. 1 is a diagram of a seismic sensing system (100), according to one example of the principles described herein. The seismic sensing system (100) comprises a command center (102), a processing, center (104), and an array of sensors (106) distributed within a target area (108). In one example, the seismic sensing system (100) is used to detect presence of a desired resource (110) such as oil or gas within the geological features in which the seismic sensing system (100) is deployed.

Pie command center (102) may be located relatively closer to the target area (108) than the processing center (104), and the computing devices within the command center (102) are used to monitor the daily activities performed at the target area (108) and process data representing the environmental information detected and transmitted by the sensor array (106), as described in more detail below. The command center may comprise a survey operation device (120) for carrying out the functions of the present disclosure. The survey operation device (120) is described in more detail below. In one example, the survey operation device (120) may be embodied in the command center (102) as depicted. In another example, the survey operation device (120) may be embodied in the processing center (104). In still another example, the survey operation device (120) may be separate from but communicatively coupled to the command center (102) and the processing center (104).

The processing center (104) may be located relatively further from the target area (108) than the command center (102). The processing center (104) also comprises a number of computing devices that, among other activities, process the data representing the environmental information detected and transmitted by the sensor array (106), and produce information useful to the exploration of the resource (110) within a subterranean area (112) of the land. This information may include, for example, information regarding the location of the desired resource (110) within the subterranean area (112), and potential drilling paths to obtain the resource (110), among others.

The sensor array (106) distributed within a target area (108) is used to directly of indirectly detect the resource (110). The sensor array (106) is made up of any number of sensor devices that detect any number of environmental or physical quantities, and convert it into a signal which can be interpreted by a computing device. In one example, the sensor array (106) comprises any number of sensors. In another example, the number of sensors within the sensor array (106) may be between, one and one million sensors. In still another example, the number of sensors within the sensor array (106) may be greater than one million sensors. In still another example, the sensor array (106) comprises approximately one million sensors. In the example of approximately one million sensors, the sensors may be uniformly or non-uniformly distributed throughout the target area (108). In one example, the approximately one million sensors are distributed uniformly within the target area (108) in an approximately grid manner by dividing the target area (108) into enough subsections to provide approximately one million vertices within the target area (108) at which the approximately one million sensors are paced.

In one example, the target area (108) has an area of approximately 1,600 square kilometers, and the approximately one million sensors are spread over the 1,600 square kilometer area. Operating and supporting such a big survey is an unprecedented task. The present systems and methods provide for planning and monitoring of daily survey operations and an overall survey operation.

In one example, the sensors within the sensor array (108) are analog sensors, digital sensors, or a combination thereof. The individual sensors within the sensor array (106) may be, for example, seismometers that measure seismic waves or other motions of the ground. In another example, the individual sensors within the sensor array (108) may be accelerometers that measure proper acceleration in the x-, y-, and z-axis, in this example, an accelerometer is a microelectromechanical systems (MEMS) based accelerometer. In still another example, the individual sensors within the sensor array (106) may be gravity gradiometers that are pairs of accelerometers extended over a region of space used to detect gradients in the proper accelerations of frames of references associated with those points. In yet another example, the individual sensors within the sensor array (106) may be any other type of sensing device used to detect any other environmental parameter, or combinations of the above examples as well as other types of sensors.

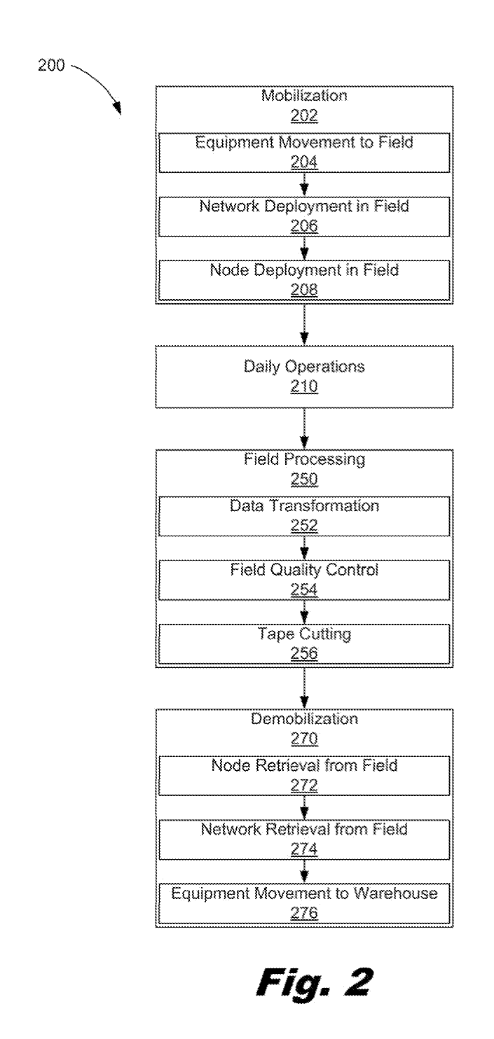

FIG. 2 is a diagram of a survey operation (200), according to one example of the principles described herein. Seismic reflection surveying is a process of resolving the detailed subsurface structural and stratigraphic conditions with reflected sound waves, and is used in imaging the potential oil reservoirs in three dimensions. Some seismic surveys are performed at small to medium scale due to limited capability of the current system and crews. To address the need for a system capable of surveying large to ultra-large areas, the present systems and methods are leveraged. The present systems and methods assist in the deployment and connection of up to one million light-weight, low-power, ultra-capable sensors through a wireless network while under the operational control of a command and control application.

The present large-scale surveys may last four to six months, cover hundreds of square kilometers, employ scores of people, and utilize a large variety of equipment. This complicated logistical operation is commonly carried out in the remote and difficult terrains like the desert of Oman and icy terrain of Canada. Only a few companies referred to as seismic service providers are capable of handling these large-scale jobs and bidding processes. Therefore, these survey contracts (service level agreements or SLAB) are highly competitive.

After winning the contract, a seismic service provider set as a goal to optimize its processes, equipment, resources, and personnel to complete the survey operation in the allocated time and budget set by the SLA. Over-provisioning equipment and resources is extremely expensive and may erode the profitability further. Also, under-provisioning equipment and resources is extremely expensive as it may delay or make it impossible to complete the survey process. A survey crew's main goal is to satisfy all contractual requirements including environmental and regulatory compliance requirements while operating within the allocated budget.

A seismic survey operations cycle can be visualized at three levels. The first level covers the entire duration of the survey. The second level deals with the daily activities and processes performed during the survey. The third level deals with the crew and equipment both individually and collectively. FIG. 2 depicts these levels. At the beginning of a survey, mobilization (202) occurs. During mobilization (202), all the equipment is delivered to the processing center (FIG. 1, 104). The equipment may comprise, for example, the sensor devices, the vibroseis trucks, and various computing devices, among other equipment or resources. Further, in one example of the survey configuration scenarios, personnel will deploy (206) the sensor network in the field. Network deployment comprises deploying (208) the approximately one million sensors along with hundreds of network aggregators in the field covering an area of 4800 square kilometers.

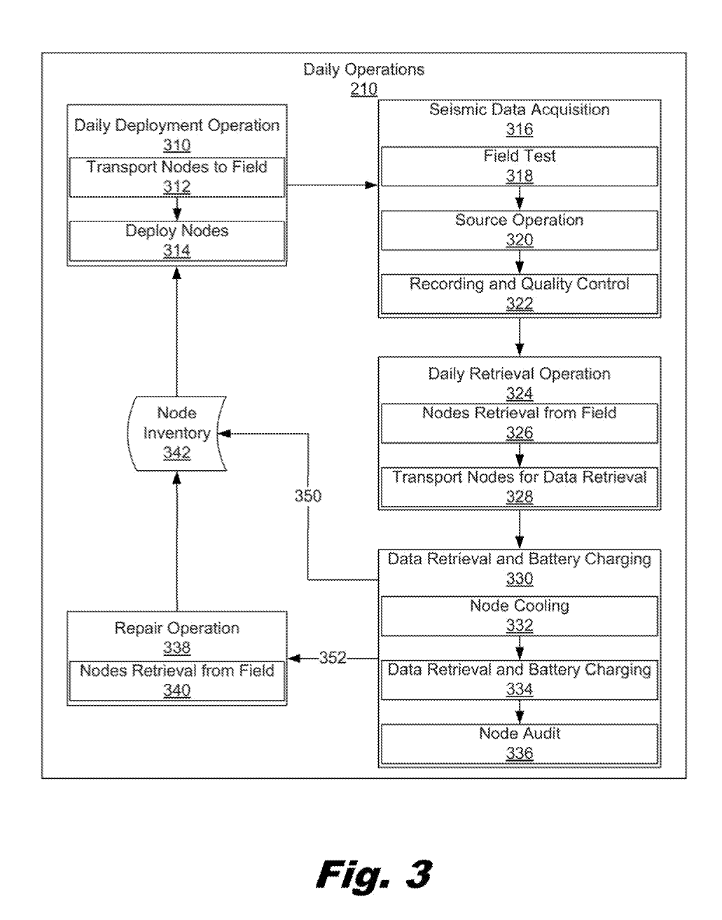

After initial deployment of sensors and mobilization (202) in general are complete, daily operations (210) are performed. The daily operations are described in more detail below in connection with FIG. 3. The survey operation (200) may further comprise field processing (250). Field processing (250) may comprise, for example processing of data harvested from the individual sensors within the sensor array (108). The sensors are rotated through the survey operations such that, at any given time, a number of sensors may be removed from the field, have the data they had collected uploaded and stored, have their batteries charged, and redeployed in the same or a different position in the field. The field processing (250) comprises data transformation (252) in which the harvested data is compiled and arranged so that the data can be presented in a useful and client-readable format. The harvested data is also subjected to a field quality control (254) where the quality of the data harvested is checked. Also, the data may be subjected to a tape cutting (256) process where the data is arranged and organized in a format the client expects. The field processing may be handled by computing devices deployed within the processing center (FIG. 1, 104).

At the end of the survey operation (200), demobilization (270) occurs. Demobilization comprises retrieval (272) of the nodes from the field, retrieval (274) of the network from the field, and movement and storage (276) of the equipment to a warehouse for later use in a subsequent survey process. The present systems and methods assist in the control and avocation of resources throughout the mobilization (202), daily operations (210), and demobilization (270), whereas field processing (250) is generally performed autonomously via a number of computing devices.

FIG. 3 is a diagram of daily operations (210) of the survey operation (200) of FIG. 2, according to one example of the principles described herein. After the initial deployment of sensors is complete, the daily operations cycle (210) generally comprises three parallel processes: retrieval of sensors and network aggregators marked for retrieval; day-to-day seismic data acquisition; and deployment of sensors and network aggregators to the leading edge of the survey area. While the signal-generation and recording steps of the survey are the reason for the survey, personnel and their equipment should act in concert to support the operation efficiently. For example, the cycle for a transport vehicle used to transport equipment starts with the driver asking for a work assignment or notifying a manager of the drivers availability. When work becomes available, the manager gives the transport vehicle an assignment, the driver picks up the equipment, drops it off and goes on to another assignment, and the cycle repeats. The cycle can also include scheduled maintenance of the transport vehicle such as oil checks and refueling, as well as unscheduled breakdowns and repairs.

As there are many inter-dependent processes in a large-scale survey operation (FIG. 2, 200), delay due to variable or random events such as equipment failures and weather changes in a process step may have a cascading impact on the overall survey schedule. This may ultimately lead to an adverse impact on the costs incurred by the seismic service provider under the SLA. Moreover, if the survey schedule is impacted, it may also lead to degradation of the deployed equipment or other resources. For example, battery thresholds for the deployed sensors may get breached leading to a number of sensors not performing as intended.

Turning again to FIG. 3, the daily operations (210) may comprise a daily deployment operation (310) in which a number of nodes or sensors are transported (312) to the field and deployed (314). The sensors are loaded into a vehicle such as the above-described transport vehicle, taken to a portion of the survey area on which the sensors are to be deployed, and positioned in and on the ground using, for example, a global positioning system (GPS).

The daily operations (210) may further comprise acquisition (316) of seismic data. Seismic data acquisition (316) may comprise field testing (318). Field testing comprises the use of the above-described vibroseis trucks to stimulate the ground and ensure that the sensors deployed in the field are functioning as intended. Seismic data acquisition (316) may further comprise source operation (320) where the same vibroseis trucks or other stimulating devices are used to create a source that the sensors can detect as described above. Still further, seismic data acquisition (316) may comprise the recordation and quality control checks (322) of the data detected and transmitted by the sensors to, for example, the command center (FIG. 1, 102) or the processing center (FIG. 1, 104).

The daily operations (210) may further comprise daily retrieval operations (324) which comprise retrieval of nodes from the filed (326) and transporting of nodes for data retrieval (328). Once the nodes have successfully recorded a sufficient amount of data, that data may be uploaded to a data storage device located at the command center (FIG. 1, 102) or the processing center (FIG. 1, 104). Thus, a number of the sensors are collected from the target area (FIG. 1, 108) and brought to the command center (FIG. 1, 102) or the processing center (FIG. 1, 104) in order to upload the data contained in the sensors.

Data retrieval and battery charging (330) may also be part of the daily operations (210). This includes node cooling (332) where the sensors are allowed to be cooled to a desired temperature. It also includes data retrieval and battery charging (330) where the data the sensors recorded is uploaded to a storage device as described above, and their batteries are charged in preparation for redeployment in the field. The nodes are also audited (336) to determine if any of the sensors are not functioning correctly and need repairs. As depicted in FIG. 3, if the sensors have been audited and found to not need repairs (350), then the sensors are inventoried at the node inventory (342) and can be transported (312) and redeployed (314) as part of the daily deployment operation (310). If, however, the sensors have been audited and found to need repairs (352), the sensors are subjected to a repair operation (338). Part of the repair operation (338) may comprise retrieval of the nodes from the field (340). In this example, the health of the sensors in the field can be determined remotely, and sensor that are not functioning properly may be retrieved from the field and repaired. After being subjected to the repair operation (338), the sensors are inventoried at the node inventory (342) and can be transported (312) and redeployed (314) as part of the daily deployment operation (310).

The operations described in connection with FIGS. 2 and 3 are examples of a number of operations that may be performed within the daily operations of the seismic survey. Other operations may also be included, and the above description is not an exclusive list of operations performed. Further, a number of the above-described operations may have a number of sub-operations that are performed.

The operations described in connection with FIGS. 2 and 3 are all interdependent processes and sub-processes. Abnormal execution of one process or sub-processes, may adversely affect a number of other processes and sub-processes within the overall survey. For example, execution of one process or sub-process too early or too late may drastically affect a number of other processes and sub-processes. The present systems and methods assist a contractor in ascertaining the impact of an abnormal execution of a process or sub-process on other processes and sub-processes, plan for future processing to overcome negative effects of the abnormal execution, and avoid future problems within the overall survey. Thus, the present systems and methods provide for a thorough understanding of the interdependencies between processes and sub-processes within the survey.

All of the above operations described in connection with FIGS. 2 and 3 define a number of parameters. These parameters may be fixed parameters or control parameters. Fixed parameters are parameter's of the operations that are known and do not change such as, for example, survey geometry data and equipment characteristics such as weight of the sensors and range of a network aggregator. Control parameters are those parameters that relate to the day-to-day operation parameters such as, for example, operating hours, retrieval rate, and transport time. Tables 1 and 2 describe a number of fixed and control parameters, respectively, that are associated with the daily retrieval operations (324) described above in FIG. 3. Tables 1 and 2 are examples of parameters defined by the retrieval operations (324). However, other operations throughout the overall survey process (FIG. 2, 200) may comprise any number of fixed and control parameters,

TABLE 1
Fixed parameters for the retrieval operations of the survey

| Survey Fixed Parameters | Source of Information |
|---|---|
| NBR_NODES_PER_FAT_LINE | Computed based on given Survey |
| | Design |
| NBR_FAT_LINES_TO_RETRIEVE | Determined based on target data |
| | acquisition rate |
| NBR_NODES_CARRY_PER_ | Determined based on Node weight |
| PERSON | and HSE Constraint |
| NBR_NODES_TO_RETRIEVE | = NBR_NODES_PER_FAT_LINE * |
| | NBR_FAT_LINES_TO_RETRIEVE |
| NBR_NODES_CARRY_PER_ | Determined based on Truck Capacity |
| TRUCK | and HSE Constraint |

TABLE 2
Control parameters for the retrieval operations of the survey

| Survey Control Parameters | Source of Information |
|---|---|
| PICKUP_OPERATING_HRS | Determined based on Day Light, HSE |
| | Constraint and local laws |
| PICKUP_RATE__PER_PERSON | Determined based on efficiency of Pickup |
| | Crew, terrain, HSE Constraint and local laws |
| PICKUP_CREW_SIZE_COMPUTED | = (NBR_NODES_TO_RETRIEVE/PICKUP_OPERATING_HRS)/ |
| | (PICKUP_RATE_PER_PERSON) |
| TIME_TO_COOL_NODES | Determined as on Day Time Temperature |

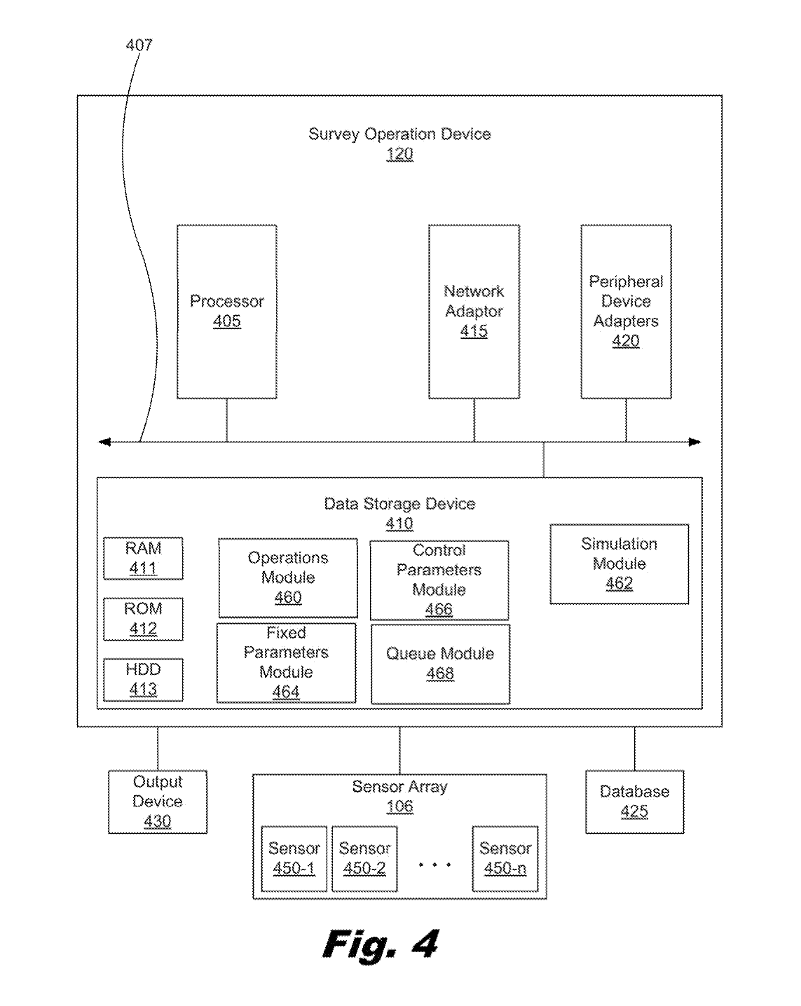

FIG. 4 is a diagram of survey operation device (120) of the seismic sensing system (100) of FIG. 1, according to one example of the principles described herein. The survey operation device (120) comprises a processor (405), a data storage device (410), a network adaptor (415), and a number of peripheral device adaptors (420). These elements are communicatively coupled by bus (407).

The data storage device (410) comprises RAM (411), ROM (412), and HOD (413). A number of software modules are stored in the data storage device (410) to, when executed by the processor (405), bring about the functionality of the survey operation device (120). Specifically, the data storage device (410) comprises an operations module (460) for determining a number of operations within an overall survey process. The data storage device (410) further comprises a fixed parameters module (464) and a control parameters module (466) for determining a number of fixed and control parameters. Still further, the data storage device (410) comprises a queue module (468) for executing a queue equation to determine waiting times or flow times of the operations. Even still further, the data storage device (410) comprises a Monte Carlo simulation module (462). Monte Carlo methods or simulations are a class of computational algorithms that rely on repeated random sampling to compute their results. These modules are described in more detail below.

The survey operation device (120) is communicatively coupled′ to the sensor array (106) that is deployed in the target area (108). The sensor array (106) comprises a number of sensors (450-1, 450-2, 450-n). Although three sensors 1450-1, 450-2, 450-n) are depicted in the sensor array (106) of FIG. 2, any number of sensors (450-1, 450-2, 450-n) may be present within the sensor array (106). As described above, approximately one million sensors (450-1, 450-2, 450-n) may be included within the sensor array (106). The sensors (450-1, 450-2, 450-n) provide the data to the survey operation device (120) for processing as described herein.

The survey operation device (120) further comprises an output device (430). The output device (430) is any output device that provides an administrator with information processed by the survey operation device (120), and may comprise, for example, a display device, a printing device, or combinations thereof. A database (425) may be communicatively coupled to the survey operation device (120). The database (425) stores unprocessed (raw) data and processed data including, for example, a number of fixed parameters and a number of control parameters.

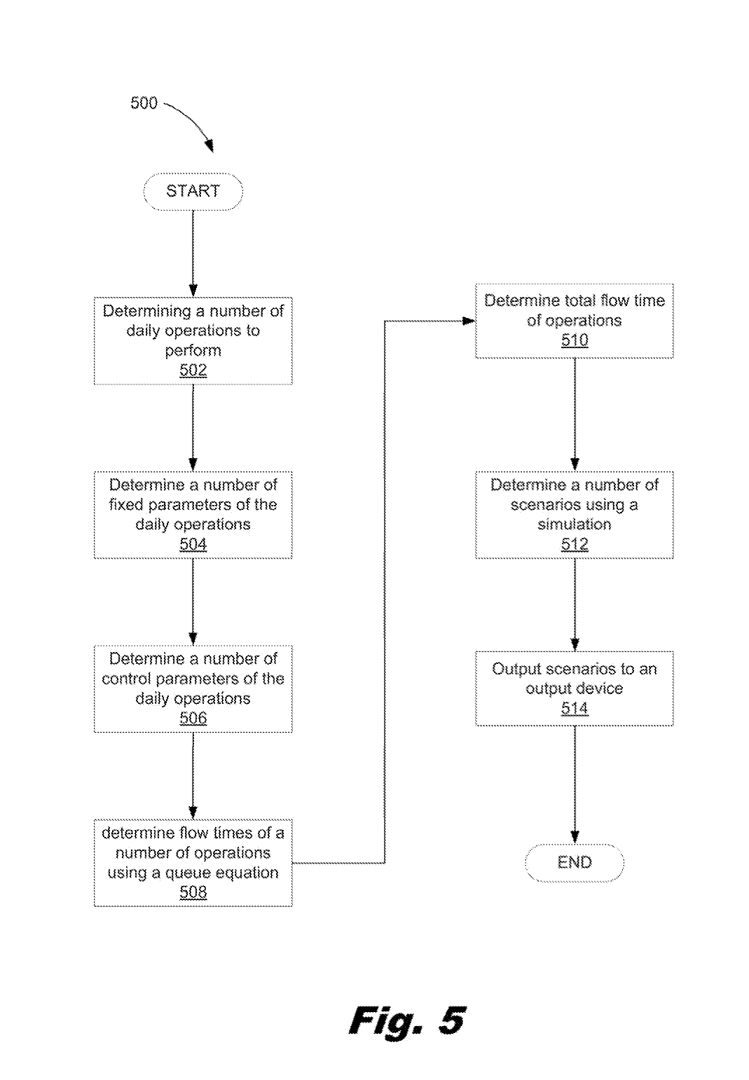

FIG. 5 is a flowchart showing a method (500) of conducting a sensor network survey, according to one example of the principles described herein. As described herein, the present systems and methods are used to predict and monitor delays that occur during the overall survey process and during day-to-day operations such as those operations described in FIGS. 2 and 3, and how one abnormal execution of one process or sub-process may adversely affect other processes and sub-processes within the overall survey. The method of FIG. 5 may begin by determining (block 502), with the processor (FIG. 4, 405) executing the operations module (460), a number of daily operations to be performed within the overall survey process. This may include a number of processes, and a number of sub-processes.

The processor (405) of the survey operation device (120) executes the fixed parameters module (464) to determine (block 504) a number of fixed parameters of the daily operations. The method determines (block 506) a number of control parameters of the daily operations by executing, with the processor (405), the control parameters module (466).

A waiting time or flow times of a number of the operations may then be computed (block 508) by executing, with the processor (405), the queue module (468). The queue module (468) utilizes a queue equation to determine the waiting times or flow times of the operations. Queuing theory is the mathematical study of waiting lines, or queues. In queuing theory, a model is constructed so that queue lengths and waiting times can be predicted. With this prediction, the system (100) can plan for a given day's operations in order to optimize resources and bring the overall survey process within the SLA's time and cost budgets. Here, the queue equation is used to determine the waiting times for the number of operations performed in the daily operations (FIGS. 2 and 3, 210), the mobilization operations (FIG. 2, 202), and the demobilization operations (FIG. 2, 270). Waiting times of the various processes and sub-processes within the overall survey process exist due to random variability on the processes or delay due to downtime of a number of resources utilized within the processes. In one example, the present systems and methods utilize the following queue equation:

$$QT = ( \frac{{C}_{a}^{2} + {C}_{e}^{2}}{2} ) [ \frac{{u}^{\sqrt{2 ( m + 1 )} - 1}}{m ( 1 - u )} ] ( \frac{P T}{A} ) \qquad Eq . 1$$

where
QT=Average Waiting time;
Cₐ²=the normalized variance (the a coefficient of variation, or “c.v.” for short) of the arrival rate
Cₑ²=Effective service time coefficient of variation, (reflects machine down time);
u=Utilization;
m=number of servers;
PT=Process Time; and
A=Availability

and where

$${C}_{e}^{2} = {C}_{0}^{2} + ( 1 + {C}_{r}^{2} ) A ( 1 - A ) ( \frac{M T T R}{P T} ) \qquad Eq . 2$$

Where
C₀²=normalized variance of the process time;
Cₓ²=normalized variance of the length of an equipment/server-down event; and
MTTR=mean time to repair.

The above queue equations may be incorporated into a spreadsheet such as, for example, a MICROSOFT EXCEL spreadsheet application developed and distributed by Microsoft Corporation. In this manner the queue equation may be programmed easily on a computer via a spreadsheet.

The following variables listed in Tables 3, 4, and 5 are examples of data that can be mined using the above queue formulas, and are based on the above fixed and control parameters:

TABLE 3
Waiting time calculation for pickup and transport

| WAITING TIME | |
|---|---|
| CALCULATION FOR | |
| PICKUP & TRANSPORT | Source of Information |
| Normalized variance of the | Determined based on variability in pickup |
| arrival rate, Cₐ² | rate |
| Transport time for each | Determined based on distance between |
| vehicle (hour), PT_PICKUP | field and BaseCamp |
| Normalized variance of the | Determined based on variability in process |
| process time, Cₒ² | time |
| Normalized variance of | Determined based or variability in |
| server-down event, Cᵣ² | equipment/server-down time |
| Availability, A | Availability of servers |
| Mean Time To Repair, | Mean Time To repair vehicle break-down |
| MTTR | or get replacement |
| Coefficient of variation for | Computed using Formula 2 |
| Service time, Cₑ² | |
| Inter-arrival Time of vehicle | = NBR_NODES_CARRY_PER_TRUCK/ |
| load for pickup (hour), a | (PICKUP_RATE_PER_PERSON * |
| | PICKUP_CREW_SIZE_COMPUTED) |
| number of vehicles, m | Simulated to keep utilization below 100% |
| utilization of vehicle, u | u = p/(a * m) |
| Average waiting time of | Calculated using Formula 1 |
| vehicle, QT_PICKUP (hour) | |
| Flow Time, FT_ PICKUP | = PT_PICKUP + QT_PICKUP |
| Minimum Flow Time, | = PT_PICKUP |
| minFT_PICKUP | |
| Maximum Flow Time, | = PT_PICKUP + (2 * QT_PICKUP) |
| maxFT_PICKUP | |

TABLE 4
Waiting time calculation for data retrieval and charging

| WAITING TIME | |
|---|---|
| CALCULATION FOR DATA | |
| RETRIEVAL & CHARGING | Source of Information |
| Normalized variance of the | Determined based on variability in |
| arrival rate, Cₐ² | transport time |
| Charge time for each node | Determined based on node and dock's |
| (hour), PT_CHARGING | capability |
| Normalized variance of the | Determined based on variability in process |
| process time, Cₒ² | time |
| Normalized variance of | Determined based on variability in |
| server-down event, Cᵣ² | equipment/server-down time |
| Availability A | Availability of servers |
| Mean Time To Repair, MTTR | Mean Time To repair pocket outage or get |
| | replacement |
| Coefficient of variation for | Computed using Formula 2 |
| Service time, Cₑ² | |
| Inter-arrival Time of vehicle | = FT_PICKUP |
| load for charging (hour), a | |
| number of Dock Pockets, m | Simulated to keep utilization below 100% |
| utilization of Dock Pockets, u | u = p/(a * m) |
| Average waiting time, | Calculated using Formula 1 |
| QT_CHARGING (hour) | |
| Flow Time, FT_CHARGING | = PT_CHARGING + QT_CHARGING |
| Minimum Flow Time, | = PT_CHARGING |
| MinFT_CHARGING | |
| Maximum Flow Time, | = PT_CHARGING + (2 * |
| MaxFT_CHARGING | QT_CHARGING) |

TABLE 5
Waiting time calculation for node audit

| WAITING TIME | |
|---|---|
| CALCULATION FOR NODE | |
| AUDIT | Source of Information |
| Normalized variance of the | Determined based on variability in transport |
| arrival rate, Cₐ² | time |
| Audit time for each node | Determined based an node and auditor's |
| (hour), PT_AUDIT | capability |
| Normalized variance of the | Determined based on variability in process |
| process time, Cₒ² | time |
| Normalized variance of | Determined based on variability in auditor |
| server-down event, Cᵣ² | down time |
| Availability A | Availability of Auditors |
| Mean Time To Repair, MTTR | Mean Time To get replacement auditor |
| Coefficient of variation for | Computed using Formula 2 |
| Service time, Cₑ² | |
| Inter-arrival Time of vehicle | = FT_CHARGING |
| load for auditing (hour), a | |
| number of Auditors, m | Simulated to keep utilization below 100% |
| utilization of Auditors, u | u = p/(a * m) |
| Average waiting time, | Calculated using Formula 1 |
| QT_AUDITING (hour) | |
| Flow Time, FT_AUDITING | = PT_AUDITING + QT_AUDITING |
| Minimum Flow Time, | = PT_AUDITING |
| MinFT_AUDITING | |
| Maximum Flow Time, | = PT_AUDITING + (2 * QT_AUDITING) |
| MaxFT_AUDITING | |

Tables 3, 4, and 5 comprise “flow times,” “minimum flow times,” and “maximum flow times” that indicate the flow times of the operations which they deal with. Any number of flow times may be determined for any number of operations performed throughout the overall survey process. Each of the above variables within Tables 3, 4, and 5 are based on what operation is being performed. Therefore, any operations may comprise any number of variables. Further, the variables listed in Tables 3, 4, and 5 are not an exclusive list of variables that may be considered.

A total flow time is computed (block 510) for the operations using the queue module (468) executed by the processor (405). In one example, the total flow time may be determined by adding the flow times of the various operations. Using the examples given in Tables 3, 4, and 5, the total flow time for a vehicle loading operations where the sensors or nodes have been picked up from the field and allowed to cool, charge, and be audited is calculated as follows:

Total Flow Time for a Vehicle Load (after pickup)=FT_PICKUP+TIME_TO_COOL_NODES_FT_CHARGING+FT_AUDITING Eq. 3

The method (500) of FIG. 5 may continue by determining (block 512) number of scenarios using a simulation based on the total flow time by executing, with the processor (402), the simulation module (462). In this manner, a total flow times for a number of operations or sub-operations may be determined. In one example, the simulation is presented using a Monte Carlo technique. As described above, Monte Carlo methods are a class of computational algorithms that rely on repeated random sampling; to compute their results. The Monte Carlo methods may be performed for three scenarios: an optimistic scenario, a likely scenario, and a pessimistic scenario. Since many controlling parameters are often stochastic and uncertain in large field operations, the above described Monte Carlo technique is used to propagate the input uncertainties into uncertainties in the results (identifying the control limits). The control limits assist an operator or administrator in formulating a realistic plan for the next day, considering resource constraints and available operating time. Based on these control limits, the survey operation device (120) can effectively monitor how a process behaves over time and alert an operator or administrator when a process is out of control during a current day's operation or a process or sub-process executes abnormally or unexpectedly. Further, the survey operation device (120) assists an operator or administrator in planning future processing if an out of control, abnormal, or unexpected process is encountered during the overall survey.

The scenarios obtained from the above processes may be output (block 514) to an output device so that the operator or administrator may understand how to schedule the current day's or a subsequent day's operations. For example, the scenarios obtained from the above processes are output (block 514) to the output device (430).

Although the present system and methods are used to efficiently plan for an overall survey project and its day-to-day operations, in one example, the above systems and methods may be used during a bidding process prior to a contract being entered into between the seismic service provider and the client. In this example, a bid to perform the survey made by the seismic service provider may be based on the findings of the above systems and methods. This utilization of the present systems and methods in bidding assist the seismic service provider in determining in what time frame the survey project may be completed, and how many of each of the resources may be needed, among other types of information.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code; when executed via, for example, the processor (405) of the survey operation device (120) or other programmable data processing apparatus, implement the functions or acts specified in the flowchart and/or block diagram block or blocks. In one example, the computer usable program code may be embodied within a computer readable storage medium; the computer readable storage medium being part of the computer program product.

The specification and figures describe systems and methods of conducting a sensor network survey. The systems and methods comprise executing an operations module to determine a number of daily operations to perform in a survey, executing a fixed parameters module to determine a number of fixed parameters of the daily operations, and executing a control parameters module to determine a number of control parameters of the daily operations. The systems and methods further comprise executing a queue module to determine flow times of the daily operations using a queue equation, executing the queue module to determine a total flow time of the daily operations, executing a simulation module to determine a number of scenarios, and outputting the scenarios to an output device. These systems and methods of conducting a sensor network survey may have a number of advantages, including: (1) computational ease: the formulas can be programmed easily on a computer via a spreadsheet, while other simulators such as Monte Carlo simulations require a significantly higher amount of programming effort; (2) the formulas enable easy interpretation of the relationships among the various variables (i.e., parameters and factors) such as capacity and utilization whereas the Monte Carlo simulation is less direct; (3) compared to intuition and “back-of-the-envelope” calculations the present systems and methods have the advantage of considering statistical variabilities numerically represented as variances, or coefficients of variation that have a major impact on waiting times and process delays, among other advantages described herein.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of conducting a sensor network survey comprising:
with a processor:
determining a number of daily operations to perform in a survey;
determining a number of fixed parameters of the daily operations;
determining a number of control parameters of the daily operations;
determining flow times of the daily operations using a queue equation;
determining a total flow time of the daily operations;
executing a simulation module to determine at least one scenario; and
outputting the at least one scenario an output device.

2. The method of claim 1, in which the queue equation comprises:
$$QT = ( \frac{{C}_{a}^{2} + {C}_{e}^{2}}{2} ) [ \frac{{u}^{\sqrt{2 ( m + 1 )} - 1}}{m ( 1 - u )} ] ( \frac{P T}{A} )$$
in which QT is an average waiting time;
Cₐ² is a normalized Variance of the arrival rate;
Cₑ² is an effective service time coefficient of variation;
u is an utilization;
m is a number of servers;
PT is a process time; and
A is an availability,
and in which
$${C}_{e}^{2} = {C}_{0}^{2} + ( 1 + {C}_{r}^{2} ) A ( 1 - A ) ( \frac{M T T R}{P T} )$$
in which
C₀² is a normalized variance of the process time;
Cₓ² is a normalized variance of the length of an equipment/server-down event; and
MTTR is a mean time to repair.

3. The method of claim 1, in which the simulation module is a Monte Carl simulation module that utilizes Monte Carlo simulation methods.

4. The method of claim 1, in which executing the queue module to determine the total flow time of the daily operations comprises adding the flow times of the daily operations.

5. The method of claim 1, further comprising planning for a subsequent day's daily operations based on the determined total flow time of the daily operations on a current day.

6. A survey operation device comprising:
a processor; and
a data storage device coupled to the processor, in which the data storage device comprises:
a fixed parameters module to determine a number of fixed parameters of a number of operations to perform in a survey;
a control parameters module to determine a number of control parameters of the operations;
a queue module to determine flow times of the operations using a queue equation and to determine a total flow time of the operations; and
a simulation module to determine at least one scenario.

7. The survey operation device of claim 6, in which the simulation module determines an optimistic scenario, a likely scenario, a pessimistic scenario, or combinations thereof.

8. The survey operation device of claim 6, further comprising a number of sensors within a sensor array deployed across a target area to detect a number of environmental parameters in the target area.

9. The survey operation device of claim 8, ire which the sensors are Richter sensor nodes.

10. The survey operation device of claim 8, in which the sensor array comprises approximately one million sensors.

11. A computer program product for conducting a sensor network survey, the computer program product comprising:
a computer readable storage medium comprising computer usable program code embodied therewith, the computer usable program code comprising:
computer usable program code to, when executed by a processor, determine a number of operations to perform in a survey;
computer usable program code to, when executed by the processor, determine a number of parameters of the operations;
computer usable program code to, when executed by the processor, determine flow times of the operations using a queue equation;
computer usable program code to, when executed by the processor, determine a total flow time of the operations; and
computer usable program code to, when executed by a processor, determine a number of scenarios.

12. The computer program product of claim 11, further comprising computer usable program code to, when executed by the processor, create a survey plan prior to conducting the survey plan bidding on a survey contract.

13. The computer program product of claim 11, in which the computer usable program code to, when executed by the processor, determine a total flow time of the daily operations comprises computer usable program code to, when executed by the processor, add the flow times of the operations.

14. The computer program product of claim 11, further comprising:
computer usable program code to, when executed by the processor, alert an administrator of an abnormal execution of a process, and
computer usable program code to, when executed by the processor, present a plan to alleviate adverse effects of the abnormal execution on a number of interdependent processes.

15. The computer program product of claim 11, in which the computer usable program code to, when executed by the processor, determine a number of scenarios utilizes a number of Monte Carlo simulation methods.
